(19) United States
(12) Patent Application Publication
(10) Pub. No.: US 2022/0167468 A1
(43) Pub. Date: May 26, 2022

(54) ELECTRIC RANGE

(71) Applicant: LG ELECTRONICS INC., Seoul (KR)

(72) Inventors: Sangbeom KIM, Seoul (KR); Junghyeon CHO, Seoul (KR)

(21) Appl. No.: 17/513,686

(22) Filed: Oct. 28, 2021

(30) Foreign Application Priority Data
Nov. 25, 2020 (KR) 10-2020-0159560

(51) Int. Cl. H05B 6/06; H01F 27/24; H05B 6/36

(52) U.S. Cl. CPC H05B 6/062; H05B 6/365; H01F 27/24

(57) ABSTRACT

According to an embodiment, an electric range includes a core frame. The core frame includes a withdrawal portion on a top surface thereof, formed by removing a portion of a guide rail. The withdrawal portion is configured to guide withdrawal of a working coil to outside of the core frame. A portion of the working coil is disposed on the withdrawal portion. Thus, the number of windings of the working coil around the guide rail of the core frame, a total winding length of the working coil, and a winding range of the working coil is easily adjusted.

### CROSS-REFERENCE TO RELATED APPLICATION

This application claims priority to and the benefit of Korean Patent Application No. 10-2020-0159560, filed on Nov. 25, 2020, which is hereby incorporated by reference as if fully set forth herein.

### TECHNICAL FIELD

The present disclosure relates to an electric range, and one particular implementation relates to an induction heating type electric range.

### BACKGROUND

The content described in this section merely provides background information on the present disclosure and does not explain the related art.

Various types of cooking appliances may be used to heat food at home or in a restaurant. For example, a cooking appliance may include a gas range using gas and an electric range using electricity. Also, an electric range may use a resistance heating method and an induction heating method.

An electrical resistance method may generate heat by applying electric current to a non-metallic heating element such as a metal resistant wire or silicon carbide, and may radiate or conduct the generated heat to heat an object (e.g., a cooking vessel such as a pot or a frying pan).

An induction heating method may apply high-frequency power to a coil to generate a magnetic field around the coil and heat an object made of metal using an eddy current generated from the magnetic field. Thus, when electric current is applied to a working coil or a heating coil, heat is generated by induction and may heat the object.

Most of brackets that support various components of an electric range may have a plate-shaped structure, and the plate-shaped structure may become deformed due to the load of the components thereof or an external force. Therefore, developing a structure capable of increasing rigidity of the brackets may be needed.

A heating portion of an electric range may include a working coil and a ferrite core, and when high-frequency power is applied to the working coil, a magnetic field (i.e., an electromagnetic field) may be generated around the working coil.

In this example, the electric range may need to adjust the range of magnetic field generated by the heating portion and intensity of the magnetic force generated from the magnetic field. To facilitate the adjustment, a structure capable of freely changing the number of windings of a working coil wound around the heating portion, an overall winding length, and a winding range of the working coil may be needed.

### SUMMARY

According to an embodiment of the present disclosure, an electric range configured to adjust the range of magnetic field may be provided. The magnetetic field generated by a heating portion and intensity of a magnetic force generated from the magnetic field may be adjusted while maintaining the same size of the heating portion.

According to an embodiment of the present disclosure, an electric range configured to adjust the number of windings of a working coil wound around a heating portion, a total winding length, and the winding range of the working coil while maintaining the same size of the heating portion may be provided.

According to an embodiment of the present disclosure, an electric range with working coil wound around a portion of a guide rail of the heating portion may be provided. The working coil may be configured to be withdrawn from the guide rail to outside of the heating portion.

According to an embodiment of the present disclosure, an electric range may include a core frame. The core frame may include a withdrawal portion on a top surface thereof. The withdrawal portion may be formed by removing a portion of a guide rail. The withdrawal portion may be configured to guide withdrawal of a working coil to outside of the core frame. In one embodiment, a portion of the working coil may be disposed on the withdrawal portion. As such, the number of windings of the working coil around the guide rail of the core frame, a total winding length of the working coil, and a winding range of the working coil may be easily adjusted.

According to an embodiment of the present disclosure, the withdrawal portion may be disposed at an edge of the core frame. Accordingly, the working coil may be wound around a portion of the guide rails adjacent to the central portion of the core frame in a spiral like shape or pattern and may be wound around only a portion of the guide rails adjacent to the edge of the core frame.

According to an embodiment of the present disclosure, the withdrawal portion may be formed by removing a portion of the plurality of guide rails that are consecutively arranged in a radial direction from the center of the core frame. In this exemplary structure, grooves of the plurality of guide rails configured to receive the working coil may be spaced apart from one another and may be arranged in a predetermined diameter direction of the core frame, and the groove of the plurality of guide rails may meet (or be coupled or connected) to the withdrawal portion. With this exemplary structure, the number of windings of the working coil around the plurality of guide rails may be adjusted similarly in the manner as described above.

According to an embodiment of the present disclosure, the withdrawal portion may be formed by removing a portion of the guide rail that is disposed in a circumferential direction of the core frame. A width of the withdrawal portion may be appropriately selected or determined in the range that is greater than the diameter of the working coil to stably (or firmly) place (or support) the working coil.

According to an embodiment of the present disclosure, an outlet of the withdrawal portion disposed at or near the edge of the core frame may be appropriately arranged closer to a third insertion hole through which the working coil may be withdrawn. With this exemplary structure, the working coil may be easily inserted into the third insertion hole.

According to an embodiment of the present disclosure, an electric range may include: a case; a cover plate coupled to a top surface of the case and configured to place an object to be heated; a plurality of heating portions disposed under the cover plate and configured to heat the object; a plurality of upper brackets disposed under the heating portion and configured to support the heating portion; and a base bracket disposed under the upper bracket and including a printed circuit board.

The heating portion may include: a core frame comprising a plurality of channels disposed below a bottom surface of the core frame and arranged in a radial direction; and a plurality of ferrite cores disposed on the channel and located under the core frame.

The core frame may include: a guide rail protruding from the top surface of the core frame, having a curved shape, and configured to guide a working coil placed on the core frame to be wound in a spiral like manner or pattern.

A plurality of guide rails may be disposed in a radial direction of the core frame.

The withdrawal portion may be linearly recessed by removing a portion of the plurality of the guide rails.

The core frame may include a first insertion hole at a central portion thereof to insert the working coil.

The core frame may further include a coupler that protrudes adjacent the circumference of the core frame. The core frame may include a plurality of couplers arranged radially, and the plurality of couplers may be coupled to the upper bracket by a coupling mechanism.

The core frame may include a mounting hole at the central portion thereof configured to receive a temperature sensor and the upper bracket may include a cable insertion hole configured to receive a cable of the temperature sensor.

According to an embodiment of the present disclosure, the electric range may further include a sensor bracket configured to receive the temperature sensor and detachably coupled to the mounting hole.

The channel may include a mounting groove configured to receive the ferrite core; and a guide line that protrudes from the bottom surface of the core frame and configured to define or arrange the mounting groove.

According to an embodiment of the present disclosure, a plurality of guide lines may be provided. The plurality of guide lines may be disposed below the core frame, and may be arranged radially. Additionally, the plurality of neighboring guide lines may be spaced apart at a central portion of the core frame in a circumferential direction thereof.

The first insertion hole may be defined at a separation portion between the neighboring guide lines.

According to an embodiment of the present disclosure, the electric range may include a withdrawal portion disposed on at least one of a central portion or an edge of a core frame. The withdrawal portion may be formed by removing a portion of the guide rail and may be configured to easily adjust the number of windings, the total winding length, and the winding range of the working coil while maintaining the same size of the heating portion.

In addition, according to the present disclosure, the electric range may adjust the number of windings of the working coil using the withdrawal portion, thereby adjusting the range of magnetic field generated by the heating portion and intensity of the magnetic force generated from the magnetic field.

In addition, according to the present disclosure, for the electric range, the withdrawal portion may stably support the working coil placed on the withdrawal portion to stably and easily withdraw the working coil from the guide rail to the outside of the heating portion.

Aspects, features, and advantages of the present disclosure are not limited to those described above. It is understood that other aspects, features, and advantages not mentioned above can be clearly understood from the following description and can be more clearly understood from the embodiments set forth herein. Additionally, it is understood that various aspects, features, and advantages described herein can be realized via means and combinations thereof that are described in the appended claims.

### BRIEF DESCRIPTION OF THE DRAWINGS

The accompanying drawings constitute a part of the specification and illustrate one or more embodiments in the disclosure, and together with the specification, explain the disclosure:

FIG. 1 is a perspective view of an example electric range according to an embodiment of the present disclosure;

FIG. 2 is an exploded perspective view of an example electric range according to an embodiment of the present disclosure;

FIG. 3 is a perspective view of examples of a base bracket and components placed on the base bracket according to an embodiment of the present disclosure;

FIG. 4 is a front view of an example electric range according to an embodiment of the present disclosure;

FIG. 5 is a cross-sectional view of the electric range according to an embodiment shown in FIG. 4;

FIG. 6 is a perspective view of the electric range according to an embodiment in FIG. 1, and for clarity of description and illustration, some components are omitted;

FIG. 7 is an exploded perspective view of some components of the electric range according to an embodiment in FIG. 6;

FIG. 8 is a perspective view of an example heating portion according to an embodiment of the present disclosure;

FIG. 9 is a plan view of the heating portion according to an embodiment in FIG. 8; and

FIG. 10 is an enlarged view of portion A according to an embodiment in FIG. 8.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention. The terms “first”, “second” and the like are used herein only to distinguish one component from another component. Thus, the components should not be limited by the terms. Certainly, a first component can be a second component unless stated to the contrary.

Throughout the disclosure, each component can be provided as a single one or a plurality of ones, unless explicitly stated to the contrary.

The singular forms “a”, “an” and “the” are intended to include the plural forms as well, unless explicitly indicated otherwise. It should be further understood that the terms “comprise” or “include” and the like, set forth herein, are not interpreted as necessarily including all the stated components or steps but can be interpreted as excluding some of the stated components or steps or can be interpreted as including additional components or steps. Throughout the disclosure, the terms “A and/or B” as used herein can denote A, B or A and B, and the terms “C to D” can denote C or greater and D or less, unless stated to the contrary. Throughout the disclosure, “a vertical direction” refers to a vertical direction of an electric range when the electric range is disposed for normal use. “A horizontal direction” refers to a direction orthogonal to the vertical direction, and a forward and rearward direction refers to a direction orthogonal to both the vertical direction and the horizontal direction. “Bilateral direction” or “a lateral direction” has the same meaning as the horizontal direction, and these terms may be used interchangeably herein.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

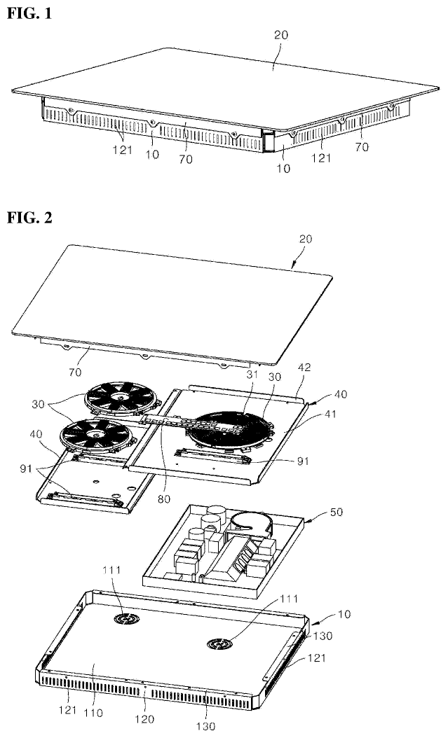

FIG. 1 is a perspective view of an electric range according to an embodiment of the present disclosure. FIG. 2 is an exploded perspective view of an example electric range according to an embodiment of the present disclosure.

The electric range according to an embodiment of the present disclosure may heat an object using an induction heating method. In this example, the object may be, for example, a dish made of metal such as stainless steel or iron.

According to an embodiment of the present disclosure, an induction heating method may include a method of generating a magnetic field around a working coil 31 by applying high-frequency power to the working coil 31 and heating an object made of metal using an eddy current caused by the generated magnetic field.

For example, a heating portion 30 may include the working coil 31 disposed adjacent to a ferrite core 330. The heating portion may apply high-frequency power to the working coil 31 to generate a magnetic field around the working coil 31, and when an object is placed in or near a region of the generated magnetic field, an eddy current caused by the magnetic field may flow through the object to cause Joule heating, thereby heating the object. Depending on the object (e.g., a dish or the like) being heated, food contained in the object may be heated and cooked accordingly.

According to an embodiment of the present disclosure, an electric range may include a case 10, a cover plate 20, a heating portion 30, an upper bracket 40, and a base bracket 50.

The case 10 may protect components of the electric range. For example, the case 10 may be made of aluminum, but is not limited thereto.

The case 10 may be thermally insulated to suppress heat generated by the working coil 31 from being emitted to outside.

The case 10 may accommodate various components of the electric range of the present disclosure. For example, the components of the electric range may include the heating portion 30, the working coil 31, the upper bracket 40, and a control board 80. The case 10 may include an upper surface configured to define an opening, and the opening thereof may be closed by the cover plate 20. The case 10 may have a cubical shape (or any other suitable shape), which may be formed by processing the plate material.

The case 10 may include a first casing 110, a second casing 120, and a third casing 130. The first casing 110 may be configured to define a bottom surface of the case 10. The first casing 110 may support inner components of the electric range.

The first casing 110 may accommodate a printed circuit board 51 and include at least one ventilation hole 111 through which air flows to facilitate cooling of circuit element components placed on the printed circuit board 51.

The second casing 120 may be bent from the first casing 110 and may define a side surface of the first casing 110. The second casing 120 may be bent from an edge of the first casing 110 in a vertical direction and define the side wall of the electric range according to an embodiment of the present disclosure. The second casing 120 may surround the side wall of the base bracket 50.

The second casing 120 may be disposed on each of sides of the first casing 110 having a substantially rectangular shape. The second casing 120 may reinforce the rigidity of the casing 110. That is, the second casing 120 bent from the first casing 110 may suppress the plate-shaped first casing 110 from being curved (or deformed) or damaged by the weight of the internal components thereof or an external force.

The second casing 120 may further include a plurality of exhaust holes 121 defining slits. The plurality of exhaust holes 121 communicates air to flow from inside of the case 10 to outside of the case 10, thereby cooling the components accommodated in the case 10.

The third casing 130 may be bent from the second casing 120 and support the upper bracket 40. The third casing 130 may be disposed on each side of the first casing 110.

A first upper plate 41 may be disposed on a top surface of the third casing 130, forming a bottom surface of the upper bracket 40, and may be coupled to the third casing 130 by a coupling mechanism such as a bolt, but not limited thereto.

The cover plate 20 may be coupled to the top surface of the case 10 and may be configured to receive an object to be heated. The cover plate 20 may be configured to close an opening disposed on the top side opposite the bottom surface of the case 10 to protect the components accommodated in the case 10.

The object to be heated may be placed on the top surface of the cover plate 20, and the magnetic field generated by the heating portion 30 may pass through the cover plate 20 to reach the object to be heated. The cover plate 20 may be made of, for example, material including ceramic, but is not limited thereto.

An input interface may be disposed on the top surface of the cover plate 20 to receive an input from a user. The input interface may be disposed in an area of the top surface of the cover plate 20 and may display an image.

The input interface may receive a touch input from the user, and an electric range according to an embodiment of the present disclosure may be driven based on the received touch input from the user.

For example, the input interface may be a module to input a heating intensity or heating time desired by the user and may be provided as a physical button or a touch panel.

For example, the input interface may be a thin film transistor liquid crystal display (TFT LCD), but is not limited thereto.

The control board 80 may be disposed under the cover plate 20 to input one or more operation commands to an electric range according an embodiment of the present disclosure. The control board 80 may include a plurality of key switches, and the user may control the operation of the electric range by inputting the command to the control board 80 using the key switches.

In an electric range according to an embodiment of the present disclosure, the top surface of the control board 80 may contact at the bottom surface of the cover plate 20. In this example, the control board 80 may be provided at a position corresponding to the input interface.

In this example, the control board 80 and the input interface may communicate with each other by a capacitive touch input method. Accordingly, when a user inputs the control command to the input interface, the control command may be input to the control board 80.

In addition, a display may be disposed in an area of the top surface of the cover plate 20 to indicate a driving state of the electric range.

According to an embodiment of the present disclosure, a light display area may be provided on the top surface of the cover plate 20. A light source portion 91 may be disposed below the cover plate 20 and emit light to transmit the light to the user through the light display area. In this example, the light display area and the light source portion 91 may be provided at positions corresponding to each other. In one example, when a plurality of light source portions 91 are provided, the same number of light display areas may be provided on the top surface of the cover plate 20.

According to an embodiment of the present disclosure, an electric range may include a cover bracket 70 to support the cover plate 20. The cover bracket 70 is described hereinafter with reference to FIGS. 2, 4, and 5.

The cover bracket 70 may be disposed outside of each side of the upper bracket 40 and the case 10, may be coupled to the case 10, and support the cover plate 20. For example, the cover bracket 70 may be coupled to the case 10 by the coupling mechanism such as the bolt, but not limited thereto.

A plurality of cover brackets 70 may be provided and each of the plurality of cover brackets 70 may be provided at each side of the rectangular cover plate 20. Accordingly, four cover brackets 70 may be disposed on the sides of the rectangular cover plate 20.

The cover bracket 70 may include a first cover plate 710 and a second cover plate 720. The first cover plate 710 may face the second casing 120 and may be coupled to the second casing 120. The second cover plate 720 may be bent from the first cover plate 710 and may be configured to support the cover plate 20.

The cover plate 20 may be placed on the top surface of the second cover plate 720, and the second cover plate 720 and the cover plate 20 may be coupled to each other by, for example, adhesive. However, the method of coupling the second cover plate 720 and the cover plate 20 is not limited to a method using adhesive.

According to an embodiment of the present disclosure, a plurality of heating portions 30 may be disposed under the cover plate 20, and may be configured to heat an object. In an embodiment, the heating portion 30 may use an induction heating method.

In another embodiment, at least some of the plurality of heating portions 30 may use an induction heating method and the rest thereof may use an electric resistance heating method to be provided as a highlight heating device. The electric range with such structure may be referred to as “a hybrid range”.

Hereinafter, an electric range including the plurality of heating portions 30 using the induction heating method is described in accordance with embodiments of the present disclosure.

In one embodiment, the heating portion 30 may be disposed on the upper bracket 40, For example, three heating portions 30 may be provided. The number of heating portions 30 is not limited thereto. In one example, when the plurality of heating portions 30 are provided, a plurality of upper brackets 40 to support the heating portions 30 may also be provided in accordance with the number of the heating portions 30.

The heating portion 30 may include a core frame 320 and a working coil 31. The working coil 31 may be wound around the top surface of the core frame 320 in a spiral like manner or pattern, and a ferrite core 330 may be disposed under the bottom surface of the core frame 320. Accordingly, when high-frequency power is applied to the working coil 31, a magnetic field may be formed around the ferrite core 330, and the formed magnetic field may cause an eddy current to flow through an object to be heated.

The heating portion 30 is described in detail below with reference to the drawings of the present disclosure.

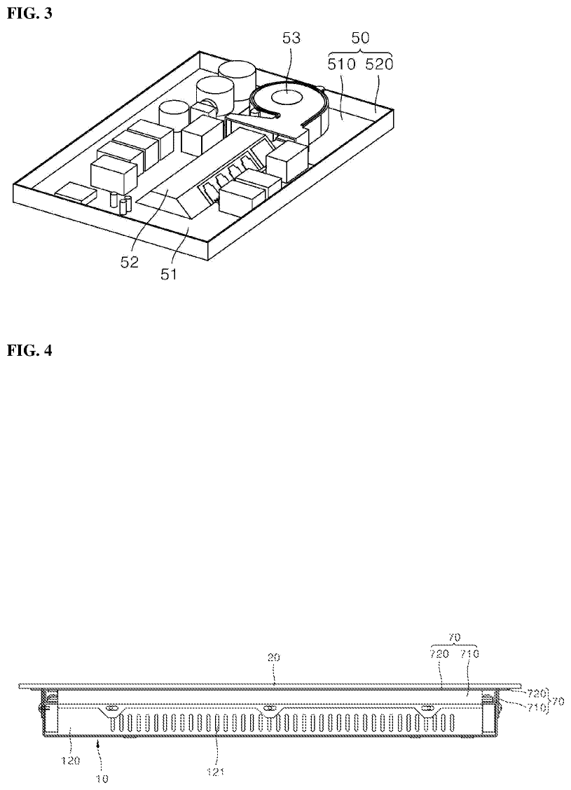

FIG. 3 is a perspective view of examples of a base bracket 50 and components placed on the base bracket 50. FIG. 4 is a front view of an example electric range.

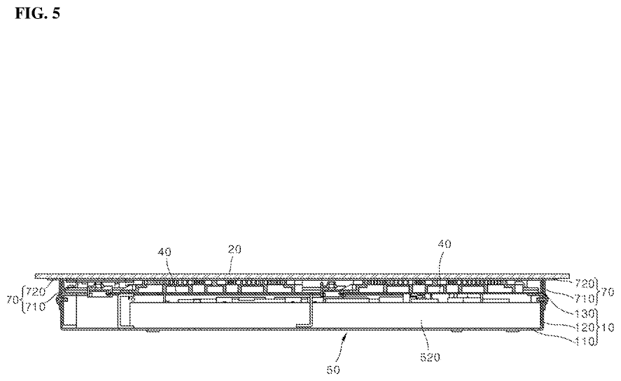

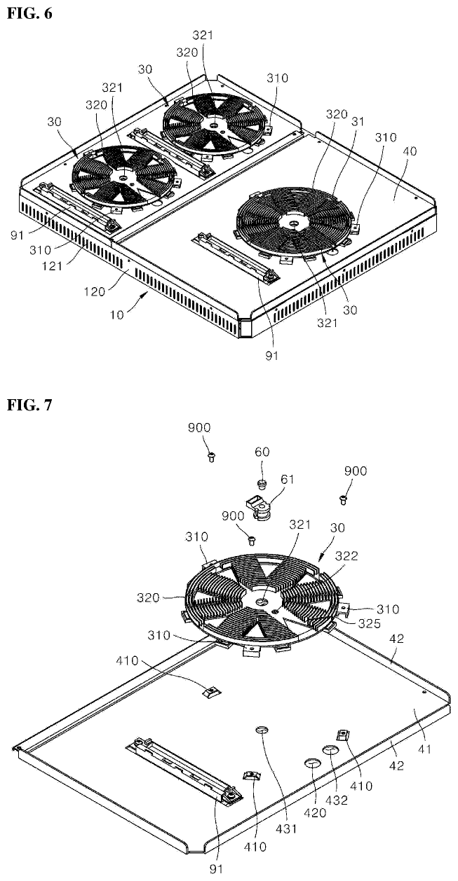

FIG. 5 is a cross-sectional view of the electric range in FIG. 4. FIG. 6 is a perspective view of the electric range of FIG. 1, with some components omitted for clarity of description.

The upper bracket 40 may be disposed under a heating portion 30 and may be configured to support the heating portion 30. In an embodiment, a plurality of upper brackets 40 may be provided. The upper bracket 40 may be made of, for example, aluminum, but is not limited thereto.

The upper bracket 40 may include a first upper plate 41 and a second upper plate 42. The first upper plate 41 may be provided to form a bottom surface of the upper bracket 40 and may be configured to receive the heating portion 30.

The first upper plate 41 may cover a printed circuit board 51 disposed below the first upper plate 41. In one embodiment, when a plurality of upper brackets 40 are provided, a single first upper plate 41 may cover the printed circuit board 51. Alternatively, a plurality of first upper plates 41 may be coupled to each other to cover the printed circuit board 51 corresponding to the size of the printed circuit board 51.

With this exemplary structure, the first upper plate 41 may block an electromagnetic field and electromagnetic waves generated from the heating portion 30 from reaching the printed circuit board 51 and the element placed on the printed circuit board 51.

That is, the upper bracket 40 may improve electromagnetic compatibility (EMC) and electromagnetic interference (EMI) performance of the printed circuit board 51.

The second upper plate 42 may be bent from the first upper plate 41 in the vertical direction of the electric range. The second upper plate 42 may be bent from an edge of the first upper plate 41 in the vertical direction.

The second upper plate 42 may be disposed on each side of the first upper plate 41 having a substantially rectangular shape. In one embodiment, when a plurality of upper brackets 40 are provided, the second upper plate 42 may be disposed on each side of the first upper plate 41 except for adjacent sides of the first upper plates 41 where adjacent upper brackets 40 may be coupled to each other.

The second upper plate 42 may reinforce rigidity of the upper bracket 40. That is, the second upper plate 42 bent from the first upper plate 41 may suppress the plate-shaped first upper plate 41 from being curved or damaged by the weight of the inner components (e.g., the heating portion 30) or an external force.

According to an embodiment of the present disclosure, a light source portion 91 may be disposed on the upper bracket 40. For example, the light source portion 91 may be disposed on the printed circuit board 51 provided below the upper bracket 40 and the upper bracket 40 may define an opening at a position corresponding to the light source portion 91. In another embodiment, the light source portion 91 may be disposed on the upper bracket 40 and may be electrically connected to the printed circuit board 51 provided below the upper bracket 40.

In one embodiment, a light display area may be disposed on the cover plate 20 at a position corresponding to the light source portion 91.

The light source portion 91 may include, for example, a plurality of LEDs arranged in a line. The light source portion 91 is turned on when the heating portion 30 is operated and may inform the user the operating state of the heating portion 30. Alternatively, the light source portion 91 may inform the user the operation state of the electric range by changing a lighting pattern and/or the color of the plurality of LEDs.

The number of light source portions 91 may be appropriately selected according to the number of heating portions 30. In FIG. 6, three light source portions 91 are provided for three heating portions 30. However, the number of light source portions 91 is not limited thereto.

The base bracket 50 may be disposed under the upper bracket 40, and may be configured to receive or mount the printed circuit board 51 thereon. Additionally, the base bracket 50 may include a bottom plate 510 and a side plate 520. The bottom plate 510 may be provided to form a bottom surface of the base bracket 50 and may be configured to receive or mount the printed circuit board 51 on the top surface thereof.

The side plate 520 may be bent from the bottom plate 510 in the vertical direction of the electric range of the present disclosure. The side plate 520 may be bent from an edge of the bottom plate 510 in the vertical direction.

The side plate 520 may be disposed on each side of the bottom plate 510 having a substantially rectangular shape. In one embodiment, when a plurality of upper brackets 40 are provided, side plates 520 may be disposed on each side of the bottom plate 510 except for the adjacent sides where the upper brackets 40 may be coupled adjacent to each other.

The side plate 520 may reinforce rigidity of the base bracket 50. That is, the side plate 520 bent from the bottom plate 510 may suppress the plate-shaped bottom plate 510 from being curved or damaged by the weight of the internal components such as a circuit board or an external force.

The printed circuit board 51 may include a controller. The printed circuit board 51 may receive power from an external power source and communicate with an external device by wire or wirelessly.

The printed circuit board 51 may be electrically connected to the control board 80 to receive a command input by the user from the control board 80. The printed circuit board 51 may be electrically connected to the light source portion 91 and the working coil 31 to control operations thereof, in accordance with embodiments of the present disclosure.

Referring to FIG. 3, the printed circuit board 51 may include an electric circuit and may be configured to receive or mount an active element and a passive element including a heat sink 52 and a blowing fan 53.

The heat sink 52 may cool the heat inside of the case 10 to protect the components accommodated in the case 10. The heat sink 52 may be disposed on the printed circuit board 51 and may cool the heat of the circuit board. In addition, the heat sink 52 may cool the heat generated by the heating portion 30 due to the electromagnetic interactions on the circuit board.

For example, the heat sink 52 may include a plurality of cooling fins and an air guide configured to cover the cooling fins and to guide air to flow to the cooling fins.

The blowing fan 53 may be disposed on the printed circuit board 51. As shown in FIG. 3, a guide wall may be disposed at an air discharge outlet of the blowing fan 53 to guide the air forcibly generated by the flowing fan 53 to flow toward the heat sink 52.

For example, when the blowing fan 53 is operated, the air inside the case 10 is forced to flow toward the heat sink 52. Thereby, the heat sink 52 may cool the inside of the case 10.

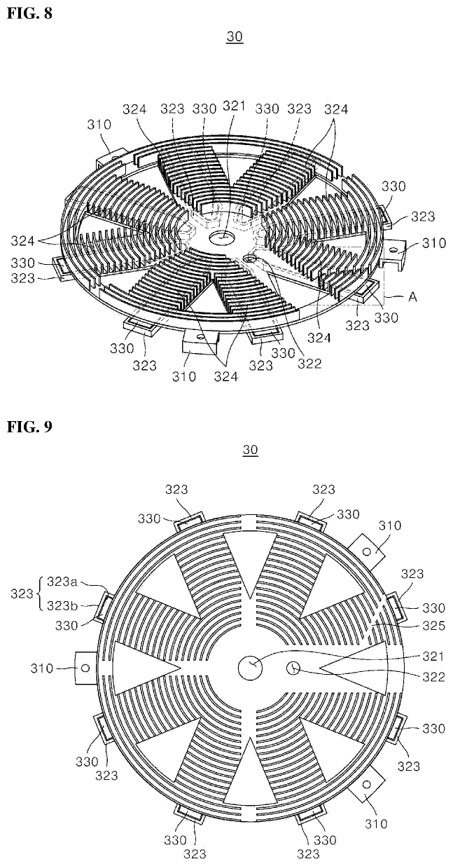

FIG. 7 is an exploded perspective view of some exemplary components of the electric range in FIG. 6. FIG. 8 is a perspective view of an example heating portion 30. For clarity of illustration and description, the working coil 31 is omitted in FIGS. 7 and 8.

The heating portion 30 and an upper bracket 40 may include couplers at positions corresponding to each other to place or mount the heating portion 30 on the upper bracket 40.

The upper bracket 40 may include a first coupler 410 that protrudes from the upper bracket 40 that is configured to couple to the heating portion 30. The heating portion 30 may include a second coupler 310 corresponding to the first coupler 410.

A plurality of second couplers 310 may protrude from the outer circumference of the core frame 320, may be radially arranged, and may each be coupled to the corresponding first couplers 410 of the upper bracket 40 by a coupling mechanism.

The plurality of second couplers 310 may be provided, may be disposed at an edge of the heating portion 30, may be spaced apart from one another in a circumferential direction, and may be arranged radially. The number of first couplers 410 may be the same as the second couplers 310, and the second coupler 310 may be disposed on the upper bracket 40 at the position corresponding to the first coupler 410.

The first coupler 410 and the second coupler 310 may be coupled to each other by fastening, for example, with a screw bolt 900.

The electric range according to an embodiment of the present disclosure may further include a temperature sensor 60 disposed at a central portion of the core frame 320. The core frame 320 may include a mounting hole 321 at the central portion thereof to receive or mount the temperature sensor 60.

The temperature sensor 60 may be electrically connected to the printed circuit board 51 disposed below the upper bracket 40 by a cable or wire. For the electric connection, the cable may pass through the upper bracket 40 to connect the temperature sensor 60 and the printed circuit board 51. For the penetration, the upper bracket 40 may include a cable insertion hole 420 to insert the cable connected to the temperature sensor 60.

In an embodiment, the electric range may include a sensor bracket 61 to couple the temperature sensor 60 to the core frame 320. The sensor bracket 61 may receive the temperature sensor 60, and the temperature sensor 60 may be detachably inserted into the mounting hole 321.

The temperature sensor 60 may measure the temperature of the heating portion 30 during operation of the electric range. In one embodiment, the heating portion 30 may be operated by an induction heating method of the present disclosure, the heating portion 30 may generate heat by electromagnetic interaction.

The heat generated by the heating portion 30 may adversely affect the heating portion 30, the printed circuit board 51 disposed below the heating portion 30, and various elements placed or mounted on the printed circuit board 51. Therefore, the electric range needs to measure a temperature of the heating portion 30 to take appropriate measures based on whether the measured temperature of the heating portion 30 exceeds a set or predetermined value.

The controller of the printed circuit board 51 may receive information on the temperature of the heating portion 30 measured by the temperature sensor 60, and based on whether the temperature of the heating portion 30 exceeds a set or predetermined value, the controller may be configured to stop the operation of the electric range or may controls the blowing fan 53 to increase the cooling capacity thereof.

The core frame 320 may include a first insertion hole 322 to insert a working coil 31 disposed on the core frame 320. The first insertion hole 322 may be defined at the central portion of the core frame 320 and may be spaced apart from the mounting hole 321 in a radial direction thereof.

Additionally, the first insertion hole 322 may be defined at a separation portion between neighboring guide lines 323b. That is, the first insertion hole 322 may be defined on the core frame 320 at a position having a predetermined distance away from the ferrite core 330.

The working coil 31 may be introduced to the top surface of the central portion of the core frame 320 through the first insertion hole 322. Further, the working coil 31 may be wound around guide rails 324 disposed on the top surface of the core frame 320 in a spiral like manner or pattern, and then may be withdrawn to outside of the core frame 320 when the winding reaches an edge at the circumference or perimeter of the core frame 320.

The working coil 31 may be electrically connected to the printed circuit board 51 disposed below the upper bracket 40. For the electrical connection, the upper bracket 40 may include insertion holes to insert the working coil 31. The insertion holes may include a second insertion hole 431 and a third insertion hole 432. The working coil 31 may be inserted through the second insertion hole 431 and may be introduced into the core frame 320. After winding on the guide rails 324, working coil 31 may be withdrawn from an edge of the core frame 320 and may be inserted into the third insertion hole 432. The third insertion hole 432 may be appropriately disposed adjacent to the edge of the core frame 320 to dispose the working coil 31.

The working coil 31 may be introduced into the central portion of the core frame 320 and may be wound around the guide rails 324 in a direction toward the edge at the circumference or perimeter of the core frame 320. The working coil 31 may then be withdrawn from the core frame 320 at the edge of the core frame 320. Accordingly, the third insertion hole 432 may be appropriately defined or disposed in the upper bracket 40 at a position corresponding to an edge at the circumference or perimeter of the core frame 320 to facilitate placement of the working coil 31 in the electric range of the present disclosure.

The working coil 31 may pass through the second insertion hole 431 of the upper bracket 40 from the printed circuit board 51 and may be introduced onto the top surface of the central portion of the core frame 320 through the first insertion hole 322.

The working coil 31 may move to the edge of the core frame 320 while being wound around the guide rails 324 disposed on the top surface of the core frame 320 in a spiral like pattern, and may be eventually withdrawn to the outside of the core frame 320.

The working coil 31 withdrawn outside of the core frame 320 may pass through the third insertion hole 432 of the upper bracket 40 and may be connected to the printed circuit board 51 again.

Hereinafter, the heating portion 30 is described in detail with reference to FIG. 8.

The heating portion 30 may include a working coil 31, a core frame 320, and a ferrite core 330. In FIG. 8, the working coil 31 is omitted for clarity of description and illustration of the structure of the heating portion 30. However, the heating portion 30 on which the working coil 31 is wound is shown in other drawings to aid understanding the present disclosure.

The working coil 31 may be a Litz wire (but not limited thereto) having high durability to generate the magnetic field by receiving high-frequency power.

The ferrite core 330 may be disposed under the bottom surface of the core frame 320 and the working coil 31 may be wound on the top surface of the core frame 320. A plurality of channels 323 may be disposed below the bottom surface of the core frame 30 and may be arranged radially. The ferrite core 330 may be disposed on the plurality of channels 323. Accordingly, the number of channels 323 may be the same as the number of ferrite cores 330.

Each channel 323 may include a mounting groove 323a to receive the ferrite core 330 and may include a guide line 323b that protrudes from the bottom surface of the core frame 320 to define the mounting groove 323a.

A plurality of guide lines 323b may be provided and may be radially disposed under the core frame 320. Additionally, each of a plurality of neighboring guide lines 323b may be spaced apart from each other in a radial direction from the central portion (or axis) of the core frame 320.

As shown in FIG. 8, the ferrite core 330 may protrude from an edge of the core frame 320 in a radial direction of the core frame 320. In some embodiments, the mounting groove 323a may not be provided and only the guide line 323b may be provided.

The channel 323 may allow each of the plurality of radially arranged ferrite cores 330 to have a separation distance between each other in the direction around the circumference or perimeter of the core frame 320.

As shown in FIG. 8, the first insertion hole 322 configured to receive the working coil 31 may be defined or arranged between the two neighboring ferrite cores 330 at or near the central portion of the core frame 320. To prevent interference between the ferrite cores 330 and the first insertion hole 322, the channels 323 disposed adjacent to the first insertion hole 322 may be appropriately spaced apart in radial directions by a distance that is greater than the diameter of the first insertion hole 322 at the central portion of the core frame 30.

The guide rails 324 may be disposed above the ferrite core 330, and the working coil 31 may be wound around the guide rails 324. The guide rails 324 may protrude from the top surface of the core frame 320. The guide rails 324 may have semi-circular (or curved) shapes and may be arranged in radial direction in a concentric manner, and may be configured to guide the working coil 31 placed onto the core frame 320 to be wound in a spiral like manner or pattern.

The guide rails 324 may be provided in radial directions of the core frame 320. The working coil 31 may be received in grooves between the guide rails 324 and may be wound along the guide rails 324 in one or more radial directions.

In order to firmly couple or attach the working coil 31 to the upper surface of the core frame 320, an adhesive may be applied to the guide rails 324 and the grooves between the guide rails 324.

The adhesive may made of thermally insulating material to electrically insulate the working coil 31.

As shown in FIG. 8, the guide rails 324 may be disposed in a consecutive manner along radial directions of the core frame 320. The guide rails 324 may be disposed to substantially cover the corresponding areas opposite to the ferrite cores 320 disposed underneath the bottom surface of the core frame 30.

Additionally, the guide rails 324 may have semi-circular (or curved) shapes and may be arranged in radial direction in a concentric manner, such that the guide rails 324 may be disposed from the central portion of the core frame 320 toward the edge thereof, and the working coil 31 wound around the guide rails 324 may have the a spiral like shape or pattern. Accordingly, the working coil 31 may be disposed beginning from the central portion of the core frame 320 to the edge thereof.

That is, the working coil 31 may be introduced onto the top surface of the core frame 320 through the first insertion hole 322, and may be wound around the guide rails 324. Accordingly, the working coil 31 may have a spiral pattern or shape, and may be withdrawn outside of the core frame 320 from the edge of the core frame 320.

The plurality of ferrite cores 330 may be provided, may be placed on the channels 323, and may be disposed under the core frame 320. The ferrite core 330 may be coupled to the mounting groove 323a of the channel 323 by an adhesive. However, the coupling method of the ferrite core 330 is not limited thereto.

When high-frequency power is applied to the working coil 31, a magnetic field is generated around the ferrite core 330. Thus, an eddy current may be generated in an object that is placed inside the magnetic field region, and Joule's heat may be generated due to the eddy current to heat the object.

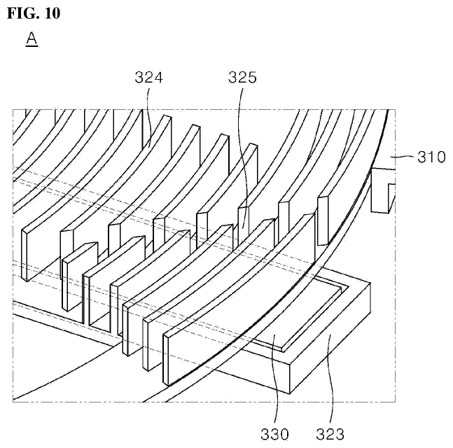

FIG. 9 is a plan view of the heating portion in FIG. 8. FIG. 10 is an enlarged view of portion A of FIG. 8. As shown in FIGS. 9 and 10, a withdrawal portion 325 may be disposed on the core frame 320.

The withdrawal portion 325 may be disposed on the top surface of the core frame 320, and may be formed by removing a portion of the guide rails 320. Accordingly, the withdrawal portion 325 may guide the working coil 31 to be withdrawn outside of the core frame 320.

The electric range in one embodiment of the present disclosure may be configured to adjust the range of the magnetic field generated in the heating portion 30. Further, the intensity of a magnetic force generated in the magnetic field may be adjusted to vary the performance (or operation) and property of the heating portion 30.

For the adjustment, the electric range in one embodiment of the present disclosure may be configured (or adapted) to adjust the number of windings of the working coil 31 around the guide rails 324 of the core frame 320, a total winding length of the working coil 31, and the winding range of the working coil 31.

In this example, the size of the core frame 320 including the guide rails 324 may be changed (or adjusted) to maintain the structure of winding the working coil 31 around the guide rail 324, and to adjust the number of windings, the total winding length, and the winding range of the working coil 31. However, this exemplary method may potentially increase the manufacturing cost of the core frame 320.

Alternatively, in one embodiment, the working coil 31 may be wound around only a portion of the guide rails 324 while maintaining the same size of the core frame 320 including the guide rail 324, thereby adjusting the number of windings, the total winding length, and the winding range of the working coil 31. In this example, the core frame 320 may also include the withdrawal portion 325.

Accordingly, the working coil 31 may be wound around only a portion of the guide rails 324, and may stop the winding around the guide rails 324 at the edge of the core frame 320 corresponding to the position of the withdrawal portion 325. Further, the working coil 31 may be withdrawn outside of the core frame 320 through the withdrawal portion 325, and may be withdrawn below the upper bracket 40 through the third insertion hole 432.

In one embodiment, when the core frame 320 does not include the withdrawal portion 325, and for example, when the working coil 31 is withdrawn through a space defined between the two neighboring guide lines 323b, an additional passage may need to be provided to guide the working coil 31 to the third insertion hole 432.

In one example, when the working coil 31 is withdrawn through the space, the portion of the working coil 31 disposed in that space may be damaged. Thus, if the working coil 31 is not supported by the core frame 320 and is partially disposed in that space, the working coil 31 that is wound around the guide rail 324 may become unwound.

Accordingly, when the working coil 31 is wound around a portion of the guide rails 324, the working coil 31 may be placed on the top surface of the core frame 320, and may be supported by the core frame 320. Further, the working coil 31 may be moved or guided toward the edge of the core frame 320, and may be withdrawn out from the core frame 320.

As shown in FIG. 10, the withdrawal portion 325 may be defined or provided at the edge of the core frame 320. Accordingly, the working coil 31 may be wound around the guide rails 324 in a spiral pattern adjacent to the central portion of the core frame 320 and may be wound around only a portion of the guide rails 324, along a radial direction, toward the edge of the core frame 320.

In one embodiment, the range of winding the working coil 31 around the edge of the guide rail 324 may be adjusted or varied. Referring to FIG. 10, the withdrawal portion 325 may be coupled or connected to the grooves of the guide rails 324 and the grooves of the guide rails 324 may be spaced apart from one another and may be arranged in radial directions of the core frame 320.

The working coil 31 may be received in the grooves of the guide rails 324. For example, the working coil 31 may be wound toward a groove of the guide rails 324, among the grooves of the guide rails 324 that meet the withdrawal portion 32, closest to the center of the core frame 320. The working coil 31 may then be withdrawn outside of the core frame 320 through the withdrawal portion 325.

Additionally, for example, the working coil 31 may be wound to a groove of the guide rails 324, among the grooves of the guide rail 324 meeting the withdrawal portion, disposed at an outermost portion of the core frame 320. The working coil 31 may then be withdrawn outside of the core frame 320 through the withdrawal portion 325.

The number of windings of the working coil 31 wound around the guide rails 324, the total winding length, and the winding range may be adjusted using the withdrawal portion 325. This may be easily done using in the manner as described above.

As shown in FIG. 10, a plurality of guide rails 324 may be provided and may be arranged in radial directions of the core frame 320. In addition, the withdrawal portion 325 may be formed by removing a portion of the plurality of guide rails 324 that are continuously arranged in a radial direction of the core frame 320.

Accordingly, the grooves of the guide rails 324 for receiving the working coil 31 may be spaced apart from one another and may be arranged in radial directions of the core frame 32, and the groove of the guide rails 324 may meet (or coupled to or connected to) the withdrawal portion 325. With this structure, the number of windings of the working coil 31 around the guide rail 324 may be adjusted in the manner as described above.

In one embodiment, the withdrawal portion 325 may be formed by removing a portion of the guide rail 324 disposed in an approximately circumferential direction of the core frame 320, as shown in FIGS. 9 and 10. That is, the withdrawal portion 325 may be formed by removing protrusions (or end portions) of the guide rails 324, as shown in FIGS. 9 and 10.

In one embodiment, the withdrawal portion 325 may not define the protrusion (or end portions) of the guide rails 324. That is, when the working coil 331 is placed on the withdrawal portion 325, the withdrawal portion 325 may stably support the working coil 31 without deforming the working coil 31.

As shown in FIG. 10, withdrawal portion 325 may be linearly recessed by removing a portion of the guide rails 324. In FIGS. 7 to 10, a longitudinal direction of the linear withdrawal portion 325 may be inclined at a predetermined angle from a predetermined diameter direction of the core frame 320, but is not limited thereto. Alternatively, the longitudinal direction of the withdrawal portion 325 may be provided parallel to a predetermined diameter direction of the core frame 320.

A width of the withdrawal portion 325 may be selected to be in the range that is configured to be greater than the diameter of the working coil 31 to so as to stably or firmly support the working coil 31 in place.

An outlet of the withdrawal portion 325 at the edge of the core frame 320 may be appropriately defined to be closer to the third insertion hole 432 through which the working coil 31 may be withdrawn. With this exemplary structure, the working coil 31 may be easily inserted into the third insertion hole 432.

In another embodiment, the withdrawal portion 325 may be disposed at the central portion of the core frame 320. casein this example, the foregoing structure of the withdrawal portion 325 may be similarly applied.

For example, withdrawal portion 325 may be disposed on at least one of the central portion or the edge of the core frame 320, thereby allowing easy adjustment of the number of windings of the working coil 31 around the guide rail 324, the total winding length of the working coil 31, and the winding range of the working coil 31.

In one embodiment, the withdrawal portion 325 may be disposed on the at least one of the central portion or the edge of the core frame 320 and may be formed by removing a portion of the guide rails 324. Accordingly, the number of windings, the total winding length, and the winding range of the working coil 31 may be adjusted while maintaining the same size of the heating portion 30.

In one embodiment, the number of windings of the working coil 31 may be adjusted using the withdrawal portion 325. Accordingly, the range of the magnetic field generated in the heating portion 30, and the intensity of the magnetic force generated in the magnetic field may be adjusted.

In one embodiment, the withdrawal portion 325 may stably (or firmly) support the working coil 31 placed in the withdrawal portion 325. Accordingly, the working coil 31 may be stably and easily withdrawn from the guide rails 324 and to outside of the heating portion 30.

The present disclosure has been described with reference to drawings hereinabove; however, the present disclosure is not limited to the embodiments and the exemplary drawings herein, and various modifications can be made by the skilled person in the art within the scope of the technical idea of the present disclosure. Further, even if working effects obtained based on the configurations of the present disclosure are not explicitly described in the description of embodiments of the present disclosure, effects predictable based on the corresponding configuration have to be recognized.

Description of Reference Numerals

| | | | |
|---|---|---|---|
| 10: | Case | 110: | First casing |
| 111: | Ventilation hole | 120: | Second casing |
| 121: | Exhaust hole | 130: | Third casing |
| 20: | Cover plate | 30: | Heating portion |
| 31: | Working coil | 310: | Second coupler |
| 320: | Core frame | 321: | Mounting hole |
| 322: | First insertion hole | 323: | Channel |
| 323a: | Mounting groove | 323b: | Guide line |
| 324: | Guide rail | 325: | Withdrawal portion |
| 330: | Ferrite core | 40: | Upper bracket |
| 41: | First upper plate | 42: | Second upper plate |
| 410: | First coupler | 420: | Cable insertion hole |
| 431: | Second insertion hole | 432: | Third insertion hole |
| 50: | Base bracket | 510: | Bottom plate |
| 520: | Side plate | 51: | Printed circuit board |
| 52: | Heat sink | 53: | Blowing fan |
| 60: | Temperature sensor | 61: | Sensor bracket |
| 70: | Cover bracket | 710: | First cover plate |
| 720: | Second cover plate | 80: | Control board |
| 91: | Light source portion | 900: | Screw bolt |

What is claimed is:

1. An electric range, comprising:
a case;
a cover plate coupled to a top surface of the case and configured to receive an object;
a plurality of heating portions disposed under the cover plate and configured to heat the object;
a plurality of upper brackets disposed under the plurality of heating portions and configured to support the plurality of heating portions; and
a base bracket disposed under at least one of the plurality of upper brackets and comprising a printed circuit board,
wherein each of the plurality of heating portions comprise:
a core frame comprising a plurality of channels disposed below a bottom surface of the core frame, the plurality of channels being radially arranged; and
a plurality of ferrite cores disposed on the plurality of channels and located under the core frame, and
wherein the core frame comprises:
a guide rail that protrudes from the top surface of the core frame, the guide rail having a curved shape and being configured to guide a working coil disposed on the core frame to be wound in a spiral pattern; and
a withdrawal portion disposed on the top surface of the core frame, the withdrawal portion formed by a removed portion of the guide rail and configured to guide a withdrawal of the working coil to an outside of the core frame.

2. The electric range of claim 1, wherein the withdrawal portion is disposed adjacent to an edge of the core frame.

3. The electric range of claim 1,
wherein a plurality of guide rails are disposed in a radial direction of the core frame and
wherein the withdrawal portion is formed by removing the portion of the plurality of guide rails that are consecutively disposed in the radial direction of the core frame.

4. The electric range of claim 3, wherein the withdrawal portion is formed by removing the portion of the plurality of guide rails disposed in a circumferential direction of the core frame.

5. The electric range of claim 4, wherein the withdrawal portion is linearly recessed.

6. The electric range of claim 1, wherein the core frame comprises a first insertion hole disposed at a central portion thereof and configured to receive the working coil.

7. The electric range of claim 1, wherein the core frame further comprises a coupler that protrudes adjacent the circumference of the core frame, the coupler being provided in plurality, arranged radially, and coupled to the upper bracket by a coupling mechanism.

8. The electric range of claim 6,
wherein the core frame comprises a mounting hole disposed at the central portion thereof, the mounting hole being configured to receive a temperature sensor, and
wherein the upper bracket comprises a cable insertion hole configured to receive a cable of the temperature sensor.

9. The electric range of claim 8, further comprising a sensor bracket configured to receive the temperature sensor and detachably coupled to the mounting hole.

10. The electric range of claim 6, wherein each of the plurality of channels comprises:
a mounting groove configured to receive the ferrite core; and
a guide line protruding from the bottom surface of the core frame and configured to define the mounting groove.

11. The electric range of claim 10, further comprising a plurality of guide lines disposed below the core frame, and arranged along a radial direction,
wherein adjacent guide lines of the plurality of guide lines are spaced apart at a central portion of the core frame in a circumferential direction thereof.

12. The electric range of claim 11, wherein the first insertion hole is arranged at a separation portion between the neighboring guide lines.

13. An electric range, comprising:
a case;
a cover plate coupled to a top surface of the case and configured to receive an object;
a plurality of heating portions, disposed under the cover plate, configured to heat the object, each of the plurality of heating portions comprising a core frame and a ferrite core, the core frame comprising a plurality of channels disposed below the core frame and arranged in a radial direction, and the ferrite core disposed on one of the plurality of channels located under the core frame; and
a plurality of upper brackets disposed under the plurality of heating portions and configured to support the plurality of heating portions,
wherein the core frame comprises:
a guide rail that protrudes from the top surface of the core frame, the guide rail having a curved shape and being configured to guide a working coil placed on the core frame to be wound in a spiral pattern; and
a withdrawal portion disposed on the top surface of the core frame, the withdrawal portion being formed by removing a portion of the guide rail and being configured to guide withdrawal of the working coil to an outside of the core frame.

14. The electric range of claim 13, wherein the withdrawal portion is linearly recessed by removing a portion of the guide rail.

15. The electric range of claim 14, further comprising a plurality of guide rails disposed in a predetermined diameter direction of the core frame,
wherein the withdrawal portion is formed by removing a portion of the plurality of guide rails consecutively arranged in a radial direction of the core frame.

16. The electric range of claim 15, wherein the withdrawal portion is formed by removing a portion of the plurality of guide rails arranged in a circumferential direction of the core frame, and
wherein the withdrawal portion is disposed adjacent to an edge of the core frame.

17. The electric range of claim 1, further comprising a ventilation hole arranged on the case.

18. The electric range of claim 1, further comprising a light source portion arranged on at least one of the plurality of upper brackets.

19. The electric range of claim 1, further comprising a plurality of light sources arranged on at least one of the plurality of upper brackets.

20. The electric range of claim 1, further comprising a fan arranged on the base bracket.
